(19) United States
(12) Patent Application Publication
(10) Pub. No.: US 2012/0324337 A1
(43) Pub. Date: Dec. 20, 2012

(54) SHARED DEFINITION AND EXPLANATION SYSTEM AND METHOD

(75) Inventors: Ernest V. Mbenkum, Toronto (CA); Mark Hempel, Edina, MN (US)

(73) Assignee: SUMBOLA, INC., Toronto (CA)

(21) Appl. No.: 13/534,627

(22) Filed: Jun. 27, 2012

Related U.S. Application Data
(63) Continuation-in-part of application No. 13/475,268, filed on May 18, 2012.
Application No. 13/475,268 is a continuation-in-part of application No. 13/474,024, filed on May 17, 2012.
Application No. 13/474,024 is a continuation-in-part of application No. 13/163,795, filed on Jun. 20, 2011.
Application No. 13/163,795 is a continuation-in-part of application No. 13/163,797, filed on Jun. 20, 2011.

(51) Int. Cl. G06F 15/16; G06F 17/30; G06F 17/00

(52) U.S. Cl. 715/234

(57) ABSTRACT

A system and method is presented for contributing explanations for words and phrases found in web-based books and text documents. Data is maintained in a database relating to books, chapters, pages, and page portions. Through the use of a user interface, users can select a text portion and submit an explanation for that portion. During review of the book by other users, the computerized system can emphasize those words and phrase for which a user has submitted an explanation. By selecting one of those page portions, a new user can be presented with the earlier submitted explanations, which will increase the new user's comprehension of the book.

### RELATED APPLICATIONS

The present application is a continuation-in-part of U.S. patent application Ser. No. 13/475,268, filed on May 18, 2012 (the '258 application). The '268 application is a continuation-in-part of U.S. patent application Ser. No. 13/474,024, filed on May 17, 2012 (the '304 patent); a continuation-in-part of U.S. patent application Ser. No. 13/163,795, filed Jun. 20, 2011; and a continuation-in-part of U.S. patent application Ser. No. 13/163,797, also filed on Jun. 20, 2011. The '304 application claims the benefit of U.S. Provisional Application 61/266,778, filed Apr. 11, 2012. All of the above applications are hereby incorporated by reference.

### FIELD OF THE INVENTION

The present application relates to the field of document review. More particularly, the described embodiments relate to a system and method for allowing a user of a web based reading system to create explanations for words and text within a document and to share those explanations with other users.

### BRIEF DESCRIPTION OF THE DRAWINGS

FIG. 1 is a block diagram showing a computerized system in used by a plurality of users, authors, and publishers.

FIG. 2 is a block diagram showing a server computer operating a web server to present interfaces over the World Wide Web.

FIG. 3 is a block diagram showing user related database elements.

FIG. 4 is a diagram showing an explanation contribution interface for one embodiment of the present invention.

FIG. 5 is a diagram showing the explanation contribution interface of FIG. 4 for a multi-word phrase.

FIG. 6 is a diagram showing a definition interface showing explanation contributions.

FIG. 7 is a flow chart showing a method for contributing explanations and reviewing explanations of third parties relating to portions of a web based document.

FIG. 8 is a diagram showing an explanation interface displaying portions for which explanations are found in the database.

FIG. 9 is a flow chart showing a method for displaying the interface of FIG. 8.

FIG. 10 is a flow chart showing a method for analyzing contributed explanations.

### DETAILED DESCRIPTION

### Overview

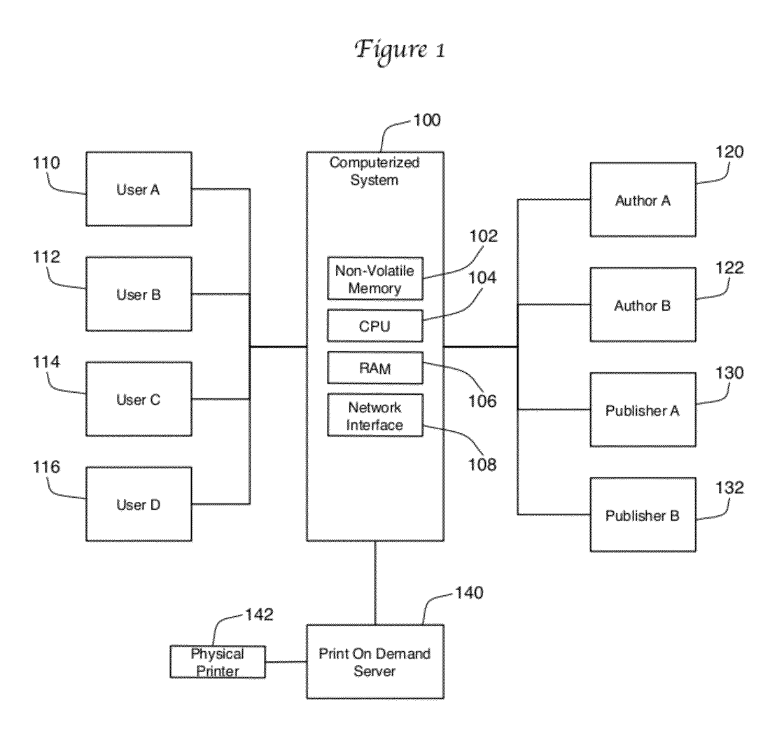

FIG. 1 is a block diagram showing a plurality of users 110-116, authors 120-122, and publishers 130-32 that are connected to a computerized system 100. The computerized system 100 provides an interactive interface to users 110-116 that allows users to page through and read one or more books. In the present description, users 110-116 are those individuals who use the computerized system 100 to read a book, to review information and content about the book, to highlight and license portions of a book, and to interact with other parties concerning that book. Authors 120-122 are those individuals who authored the books that are available for reading on the system 100. Publishers 130-132 are the entities that publish the printed version of the books, or entities that otherwise assist in the publicity for or distribution of the books.

In this description, the term author, publisher, and book are used to describe an embodiment of the present invention. However, it is not necessary that the material being read by a user constitute a book per se. For instance, the content may be a journal article, a news report, etc. The authors using the system would not then be book authors, but could be an article writer, poet, journalist, or any other type of content creator. The publisher also need not be a written book publisher, but could be any entity that works on publicity or distribution of the written content. Consequently, the word book should be construed broadly to mean written content, the word author should be construed to mean the creator of the written content, and the word publisher should be construed to mean an entity involved in publicity or distribution of the written content.

The computerized system 100 includes a set of software instructions or interfaces stored on a non-volatile, non-transitory, computer readable medium 102 such as a hard drive or flash memory device. A digital processor 104, such as a general purpose CPU manufactured by Intel Corporation (Mountain View, Calif.) or Advanced Micro Devices, Inc. (Sunnyvale, Calif.) accesses and performs the software. To improve efficiency, processor 104 may load software stored in memory 102 into faster, but volatile RAM 106. Data operated upon by the software can also be stored in non-volatile memory 102 and retrieved into RAM 106 for analysis, recording, and reporting. The computer system 100 further includes a network interface 108 to communicate with other computerized devices across a digital data network. In one embodiment, the network is the Internet or an Intranet, and the network interface 108 includes TCP/IP protocol stacks for communicating over the network. The network interface 108 may connect to the network wirelessly or through a physical wired connection. Instead of being a single computer with a single processor 104, the computerized system 100 could also implemented using a network of computers all operating according to the instructions of the software.

By using the computerized system 100, users 110-116 not only receive access to the book that they wish to read, but they also participate on a social community related to that book. These social communities include content created by, and interaction between other users 110-116 who are also reading the book, the author or authors 120-122 of the book, and other entities such as publishers 130-132 who are publicizing and attempting to generate interest in the book. This content can include notes about a particular page, chapter, or section of the book created by the users 110-116. The content can also include highlights made by the users 110-116 as they read the book.

In addition, this content can include user created explanations for words and phrases in the book. For example, user A 110 may notice that, in one location of the book, a particular word is being used in an unusual manner. By using the computerized system 100, user A 110 may select that word and contribute an explanation of its meaning in this context. Alternatively, user A 110 may wish to expound upon the meaning of an entire phrase containing the word. While user A 110 may wish to keep these explanations private, the real power in these explanations can be seen when they are shared with other users. Assuming that the explanations are being shared, user B 112 may encounter the same word and phrase and wonder about its meaning. The computerized system 100 can provide an indication to user B 112 that user submitted explanations are available for this text. If user B 112 so chooses, the computerized system 100 will then share the explanations submitted by user A 110 with user B 112. If user B 112 has a different understanding of the author's intent, user B 112 can submit her own explanations as to the meaning of that word or phrase. User C 114 may read the same page and then choose to review both the explanations of user A 110 and user B 112. In one embodiment, user C 114 may prefer one explanation to the other, and can provide feedback or ratings on these explanations to the computerized system 100.

Author A 120 may request statistics concerning user interaction with the book. The computerized system 100 can respond by informing the author 120 of the total number of users who have purchased access to the book, the number of active readers, the number of notes, highlighted passages, and explanations submitted by readers of the book, and other statistics related to the book. In addition, by tracking user interaction with the particular portions of the book, the computerized system 100 can provide author A 120 with valuable insights into the way users perceive different parts of the book. For instance, the computerized system 100 can indicate which portions contain the highest concentration of highlights, and which pages contain the greatest number of notes and the greatest amount of interaction between users 110-116. By tracking the time spent on particular pages, the computerized system 100 can also inform the author 120 which pages users read quickly, and which pages users read slowly. The author 120 may learn that users frequently look for explanations and definitions for particular words or phrases in the book. In fact, by tracking pages read over time, the computerized system can determine whether a user has effectively abandoned the reading of a particular book, and the page where the user stopped reading the book (the user's “defection point”). If this defection point occurred where users started reading more slowly and started requesting more help from definitions and explanations, the author may discover that particular sections are too dense or complex for some of their readers. Similar statistics can be made available to publishers 130-132 about their books, allowing both authors 120-122 and publishers 130-132 to obtain valuable feedback on the particular strengths and weaknesses of various books based on actual monitoring of user reading habits.

### Implementation as a Web Server

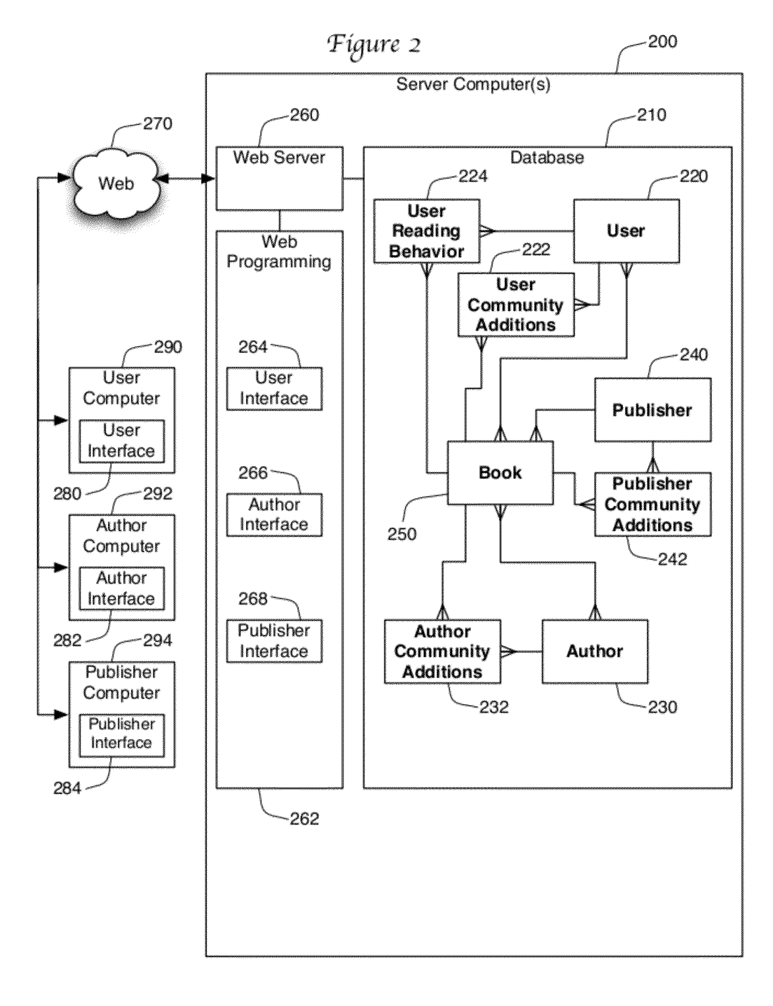

The computerized system 100 of FIG. 1 can be implemented as one or more web server computers 200 as shown in FIG. 2. The computerized system 200 is capable of storing information about all of the parties that use the system 200. In the preferred embodiment, the server computer 200 stores this information in a database 210. This information can be maintained as separate tables in a relational database, or as database objects in an object-oriented database environment within the database 110. FIG. 2 shows the database 210 with tables or objects for users 220, authors 230, publishers 240, and books 250. This allows the database 210 to maintain information about the users 110-116, authors 120-122, and publishers 130-132 that may access the server computer 200. Of course, the table or object entities shown in FIG. 2 should not be considered to show actual implementation details of the database 210, since it is well within the scope of the art to implement this type of data using a variety of entity architectures. The entities shown are exemplary, intended to aid in the understanding of the data maintained by the system database 210 in this embodiment. For example, it would be well within the scope of the present invention to divide information about users 220 into multiple tables or objects, instead of the single user entity 220 shown in FIG. 2. Similarly, it would be possible to implement the database 210 such that information about users, authors, and publishers all use a single database table or object, where the role (user, author, publisher) for each instance is defined using a field within that table or object. Finally, it is not even necessary to implement these entities as formal tables or objects, as database entities in other database paradigms could also effectively implement these types of data structures.

Relationships between these entities 220-250 as well as the other entities in the database 210 are represented in FIG. 2 using crow's foot notation. For example, FIG. 2 shows that a book 250 may have multiple authors 230, but only a single publisher 240. Each author 230 and publisher 240 can, in turn, have multiple books 250. Users 220 in the database 210 can be associated with multiple books 250, and each book 250 can itself be associated with multiple users 220. These associations allow the database to identify connections. For example, the database can identify the users reading a book by identifying the user database entities 220 that are associated with the database entity 250 for that book. “Associations” (or “relationships”) between database entities 220-250 can be implemented through a variety of known database techniques, such as through the use of foreign key fields and associative tables in a relational database model. In other embodiments, it is possible to import all of the data from the associated database entity into another entity rather than actually use a formal relationship between two different database entities, although this implementation could lead to duplicate data being stored in the database 210.

The database also tracks the contributions made to the community surrounding a book 250 by each of the various participants. For instance, each user 220 can make multiple user community additions 222 to the system 200. These additions 222 may include highlights, page notes, chapter comments, book reviews and ratings, chat room contributions, recordings, word or phrase explanations, etc. While each user 220 may make user community additions 222 about any book 250 with which they are associated in the database 210, each user community addition 222 is related to only one particular book 250. Similarly, each author 230 may make author community additions 232 to the database 210, thereby allowing the author 230 to make comments, updates, and blog posts about one of their books 250. The various community additions 222, 232, 242 that are associated with a book 250 together constitute the social community oriented around that book 250.

Users of the system 200 are given access to a book's content by associating their user record 220 with the appropriate book record 250 in the database. The text of the book is stored in the book record 250 or in related database records. Users whose record 220 is associated with the book 250 are granted access to the books' related community additions 222, 232, 242.

User interaction with the book's content through the sever computer 200 are stored in user reading behavior records 224. These records 224 can indicate when a user purchased a book, or started reading that book. These records 224 can also track other user interactions, such as tracking every time the user requests a dictionary definition for a word or otherwise interacts with the system's comprehension tools. Additional records 224 can track each page turn (or “page clicks”) by the user. Only by tracking user interaction with a book at the page level can some of the most useful information about the book and the user be generated.

The database 210 is used by a web server 260 operating on one or more of the server computers 200 to generate the various interfaces used by the system 10. In particular, web programming 262 exists that defines how to create a user interface 264, an author interface 266, and a publisher interface 268 using the data in the database 210. This programming 262 allows the web server 260 to transmit over the World Wide Web 270 (or an intranet) a user interface 280 that can be seen by a browser operating on a computer 290 for the benefit of a user. Similarly, the web server 260 can manage an author interface 282 on browser operating on an author computer 292, and a publisher interface 284 operating on a publisher computer 294. Each computer 290, 292, 294 could be a standard personal computer operating a Microsoft Windows, Linux, or Apple Mac OS operating system. Alternatively, these computers 290-294 could be mobile devices, such as smart phones or tablet computers, operating Google Android, Apple iOS, or Microsoft Windows Phone operation system. In addition, the device could be a “smart” or Internet enabled television.

### User Related Data

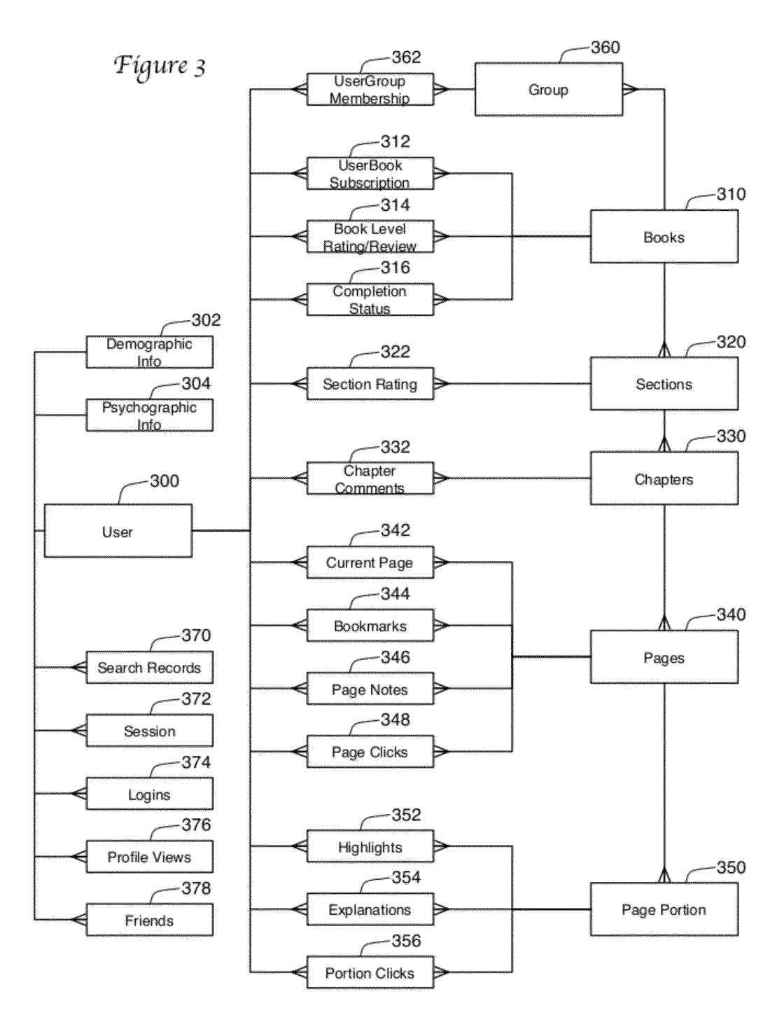

FIG. 3 shows the database elements 300-378 used by the database 210 to track information about users and their interactions with books. The user database element 300 is connected to the book element 310 primarily by the UserBook subscription 312. This element 312 indicates that the user 300 has purchased or otherwise obtained access to the book 310. Relationships between entities in FIG. 3 can be established using any of the standard techniques known in the field of database design. In the present case, a unique user ID is assigned to each user entry 300, and a unique book ID is assigned to each book entry 310. In one embodiment, other entities that relate to the user 300 or book 310 make that relationship using the user ID or book ID, respectively, either as a direct foreign key entry into the related record or through the use of associative tables.

User information, such as the user's name, address, username, password, etc. is stored in the user database element 300. Related records can also be created to store similar information. For instance, the database elements in FIG. 3 separate demographic info 302 (such as age, sex, geographic location, and income) and psychographic info 304 (such as reading preferences and past purchasing behavior) into separate elements from the user 300, even though it would be a simple matter to integrate this same information into the definition of a user table or object 300. The book element 310 itself contains information about the book (such as the book's title, date of copyright, ISBN number, etc.), although such data could also be located in separately defined database elements.

In the preferred embodiment, users 300 who have finished reading a book 310 are permitted to create a book rating and review 314 for the book 310. Users 300 who have not completed the book 310 may leave comments about parts of a book, but may not created a book level rating or review 314. The completion status detailing a user's interaction with a book is stored in database element 316.

In the embodiment shown in FIG. 3, books 310 are conceptually subdivided into sections 320. Sections 320, in turn, are subdivided into chapters 330, which are made up of pages 340. Each of these subdivisions is represented by separate database elements. In the preferred embodiment, the actual content or text of the book 410 is stored in the page level database element 440. Pages 340 themselves contain words and individual characters. In the present embodiment, some community additions 222 relate to one or more words on a page. For instance, a user may wish to highlight some words on a page and not other words, or may wish to provide an explanation for a single word on the page. In order to track data on a word level, the database 210 contains a page portion (or “text portion”) subdivision 350.

These portions 350 identify one or more words or characters on a particular page. In the preferred embodiment, pages are read by reviewing the content of the page database entities 340, and therefore the page portion entities 350 are not needed for simply reviewing the content of a book. In this embodiment, page portion database entities 350 are not created when a book is added to the database 210, in contrast with the book 310, section 320, chapter 330, and page 340 database entities. Rather, new page portion database entities 350 are created whenever needed to give context to another database element, such as the highlights 352, explanations 354, or portion clicks 356 database entities. Assuming that page portions 350 are created only when needed, pages 340 with no user community additions on the sub-page level would have not any associated page portions 350, while other pages 340 would have numerous page portions 350 defined. In an alternative embodiment, page portion database entities are not created separately from the entities 352-356 that mandate their existence. Rather, the data that would be within the page portion entity 350 is incorporated directly into the related entity 352-356. This requires that these entities 352-356 perform the function of the page portion entities 350, namely that they identify one or more words or characters on a particular page 340 of a book 310.

It is possible to implement the page portion database element 350 in a variety of ways. In one embodiment, the page portion database element 350 identifies word ranges on a page by specifying an index range for the desired words on the page. For instance, a sentence on a book page that ran from the 34^{th} word on the page to the 52^{nd} word would be identified by the portions database construct 350 by storing these numeric indexes, with the page containing these words being identified by an association in the database 210 to the correct page database entity 340. It is to be expected that a plurality of page portions 350 will include overlapping ranges within the same page as necessary to implement each of the related database entities 352-356.

In some instances, page portions 350 must be compared to one another, such as to see whether the page portions 350 relate to the same portion of a book 310 (similar context), or whether the content referred to in one page portion 350 is the same as the content in another 350 (similar content). To compare context, the page portion 350 database entities are compared to ensure that the relate to the same page 340 and book 310 database entities, and then the ranges specified by each page portion 350 are then compared. To compare content, the words or characters specified by the range of one page portion entity 350 are compared with the words or characters specified by another page portion entity 350. For example, two different page portion entities 350 might point to different pages 340 in different books 310, but the content specified by the entities 350 might both be the phrase “the game is afoot.” In this case, the two page portion entities 350 have different contexts, but identical content. To simplify the comparison of page portion content, some embodiments of the database 210 store the content pointed to by the page portion entity 350 within the entity itself 350.

One of the primary advantages of these subdivisions 320-350 is that user community additions relating to this book can be associated with the particular subdivision. For instance, users 300 are allowed to create separate section ratings 322 for each section 320, create chapter comments 332 for each chapter 330, create bookmarks 344 and page notes 346 for each page, and to create highlights 352 and explanations 354 for page portions 350.

On the page 340 level, the database tracks the current page 342 being reviewed by the user. By separately storing this information, the system allows a user to quickly return to their place within a book at later time, even after a significant delay between reading sessions. Multiple pages in a book 310 that are of particular interest to a user can be marked using bookmarks 344. The page level notes data structure 346 can contain a note left by the user. In one embodiment, page notes 346 can relate to other notes 346, thereby allowing the creation of threaded, back-and-forth discussions within the book's community. The page note database entity 346 preferably contains various users preferences about the note. For instance, the user can designate that the note is a private note that should be viewed only by the user, or designate that the note is public, thereby allowing the system 100 to share the note with all readers reaching that same page 340 of the book 310. Such private and public settings can apply to other types of user community additions 222 as well, such as book reviews 314, chapter comments 332, highlights 352, and explanations 354.

In another embodiment, the user can participate in a book's community as part of a group 360. A group 360 is a subset of all users that are reading a particular book 310. In this embodiment, a third option of sharing book reviews 314, chapter comments 332, page notes 346, highlights 352, and explanations 356 can be presented, where these additions 222 can be viewed by members of the group 360 but not by other readers of the book 310. The membership of a user 300 in a group 360 is defined by the UserGroup membership database entity 362.

Another advance made by the present invention relates to the ability to track page clicks 348. Page click entries 348 detail when a user 300 requests access to a particular page 340 of a book 310. An analysis of page click records 348 can determine whether a user 300 has completed reading a book 310, which could then be recorded in the completion status record 316. Similarly, one embodiment of the present invention may record all search requests 370 made by a user 300. Search requests may relate to a particular book 310, or may be made over multiple books 310.

In addition to page clicks 348 and search records 370, it may be useful to record user interaction with the community additions 222 such as page notes 346 and highlights 352. For instance, each time a user requests to view the highlights 352 (or page notes 346, chapter comments 332, or book review 314) of another user, the database 210 could track this viewing. In the embodiment shown in FIG. 3, a separate database entity 356 records interactions with page portions 350. This includes interactions with highlights 352, explanations 354, as well as any requests for dictionary definitions, translations, and thesaurus access of page portions made by the user as they use the computerized system 100.

One benefit of tracking user interaction with the community additions 222 of others is to help the system identify the users whose contribution to the community were most valued by other users. For example, in one embodiment, users are ranked based upon their total value to the community. Various scores are created for the users based on at least one of the following criteria: percentage of pages read for which the user created a note, percentage of chapters finished for which the user has created a chapter comment, percentage of books completed for which the user has submitted a book level review or responded to a book-related survey, number of highlights and explanations created, other user's ratings of the user-created notes, comments, and explanations, frequency of use of the user's highlights and explanations by other users, total logins in a given time period, and purchases made by the user within the system. The various scores can be weighted to create a total contribution score, which can then be compared to other users in order to value the overall contributions of that user.

Other types of user related data can also be maintained in the database, including a record of user sessions 372 and logins 374. Sessions 372 are used to keep track of a user's online status. Logins 374 track in the database 210 how often a user has logged into the site, and when they last logged in.

The system also maintains records of user interactions with other users, such as when one user views the profile of another user (profile views 376), or when one user befriends another (record 378). As seen in other social networking environments, the linking of users 300 with friends allows users 300 to explore the interests and activities of their individually selected friends.

### User Reading Interface

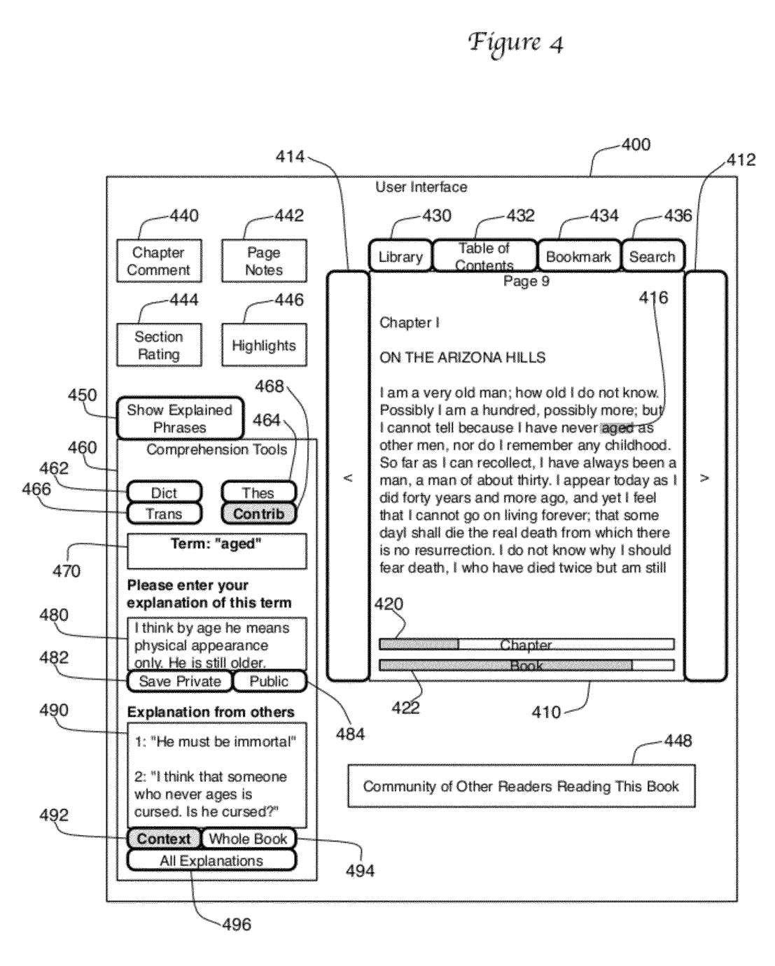

As explained above in connection with FIG. 2, a user will interact with the web-reading system of the present invention through a user interface 280 operating on a user computer 290. This user interface 280 is generated by the web server 260 operating on one or more server computers 200, and then transferred to the user computer 290 over the Internet 270, an intranet, or some other computerized network. FIG. 4 shows one embodiment of a user interface 400 that could be viewed by a user of the system of FIG. 2. This particular interface 400 is designed to allow a user to read a book that is stored in the database 210 accessed by the server computers 200. This database 210 may be constructed, in part, using the data entities shown in FIG. 3.

To make reading easier, the current page being read (element 410) dominates the interface 400. In the preferred embodiment, books are read page-by-page. Consequently, the reading user interface 400 presents a single page 410 to the user. To move the page displayed 410 from one page to the next, the user simply presses the next page button 412, which is preferable found along the entire right side of the page window 410. Similarly, the previous page button 414 is found along the entire left side of the page window 410.

At the bottom of the page window 410 are two progress bars 420, 422. These bars 420, 422 indicate at a glance how far the user currently is in the current chapter (bar 420) and the entire book (bar 422). At the top of the page window 410 are several menu buttons 430-436. The first button 430 brings the user to the library interface, where the user can select a new book. The table of contents button 432 presents the table of contents for the current book in the current page window 410. The bookmark button creates a bookmark database entry 434 for the current user at that page. Finally, the search button 436 presents the user with a search interface.

One of the benefits of the present invention is that users can create community additions 222 such as chapter comments, page notes, ratings, and highlights associated with the page 410 currently being read. In addition, the preferred embodiment allows readers to review the community additions 222 created and shared by others for that page 410. These user contributions 222 can be created and accessed through one or more user contribution interface elements 440-446 found on user interface 400. Another benefit of the present invention is the ability to find and interact with other users who are reading the same book. The community of other readers window 448 lists other users who are currently reading the same book as shown in window 410. Details concerning these elements can be found in the incorporated priority applications.

Finally, the reading interface 400 includes a comprehension tool box 460. This tool box allows users to access a dictionary, thesaurus, or translation tool by pressing buttons 462, 464, and 466, respectively. To use these tools, the user first selects a word on the current page being read 410 by moving a cursor and clicking on the selected word. The interface 400 responds by changing the appearance of the selected word, such as by adding a background color to the word as was done to the word “aged” 416 in FIG. 4. The user can then select button 462 to obtain a dictionary definition of the word 416, button 464 to obtain a thesaurus entry of synonyms for the word 416, or button 466 to obtain a translation of the word 416 into another language.

One of the benefits of the present system 100 is the ability for a user to create their own explanation for a word or phrase. This is accomplished by clicking on the “Contrib” button 468 in order to contribute an explanation for this word 416, or to view the contributed explanations made by others for this word 416. In FIG. 4, the Contrib button 468 has a grayed background, indicating that this button 468 has been selected by a user and that the remainder of the comprehension tools component 460 is showing contributed explanations for the highlighted word (as opposed to dictionary definitions, thesaurus entries, or translations).

In the preferred embodiment, the selected word is not only highlighted (416) in the page interface 410, but is also presented again at the top of the comprehension tool box 460 at location 470. This ensures that no mistake is being made by the user who is contributing an explanation for that word. In this case, the word “aged” is being analyzed. At box 480, the user is requested to enter an explanation for this term. This box 480 allows the user to type in an explanation for the term as it is being used by the author in this context. While some users may explain a term by providing a simple definition for the word, other users will provide a deeper explanation for the term based on how the term is being used by the author in this particular context. This kind of contextual explanation can be extremely beneficial to other users, as frequently the reason that an author chose a particular word goes beyond the basic dictionary definition for the word. After the user has entered text into box 480, the user can save the explanation by pressing button 482 or 484. Button 482 saves the explanation privately, meaning that only the user that created this explanation can view it at a later time. If the user wishes to share the entered explanation with others, the user would press save public button 484. A publicly saved explanation can be shared with all users 110-116 of the computerized system 100, or can be shared with a subgroup such as friends defined by database element 378 or groups defined by database element 360.

When an explanation is saved, the computerized system 100 creates an explanation database entity 354 in the database 210. This explanation database entity 354 would contain the text entered in box 480, and would identify the user that created this explanation (typically through a link to a user database entity 300). The explanation database entity 354 would also identify the portion of the page being defined, which in this case is the word “aged” found on page 9 of the currently viewed book. The identification of this page portion can be through a link to a page portion database entity 350, which is described in more detail above.

While users can store explanations privately, it is preferred that explanations be saved publicly. This allows users who are searching for meaning of a particular term to review the explanations that have been contributed by users who have previously read the term in this context. These previously contributed explanations are displayed in within box 490. In FIG. 4, two previously contributed explanations are provided for the term “aged.” In one embodiment, only a portion of each explanation is shown in box 490. A user that wishes to see the entire explanation need only select the desired explanation and the interface 400 will provide the entire text of the explanation. The interface can also provide information about the user that contributed the explanation, including their identity, whether they finished reading the book, whether they contributed any other explanations for this book, and the rankings given by others to the contributions made by this user.

The user is allowed to choose a scope for the explanations that appear in box 490 by selecting from buttons 492, 494, and 496. If the user selects the “Context” button 492, the explanations box 490 will contain only explanations for the selected use of that term (the particular location of the term on that particular page on that particular book). If the user selects a scope equal to the whole book by selecting button 494, any explanations provided for the selected term (“aged” in FIG. 4) anywhere in the current book will appear in box 490. Finally, the user can select a scope including all explanations (button 496), which will display all explanations provided for that term (“aged”) that were contributed by users for any book. Because of the importance place on contextual meaning, the most useful scope will typically be the context scope, which is selected in FIG. 4 as indicated by the shading in button 492. In some embodiments, the number of available explanations for each scope will be shown inside of the button 492, 494, and 496 used to select that scope.

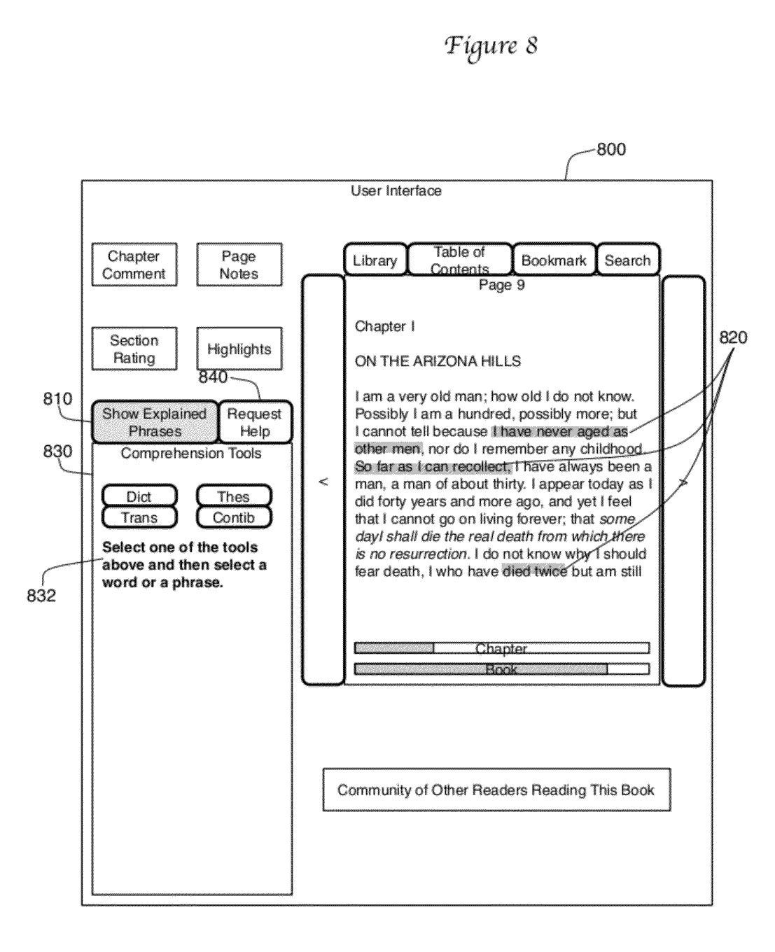

It is sometimes helpful to allow a user viewing a page 410 of a book to know which words and phrases on that page have been explained by other users. This can be accomplished by pressing the “show explained phrases” button 450, as is described in more detail in connection with FIG. 8 below.

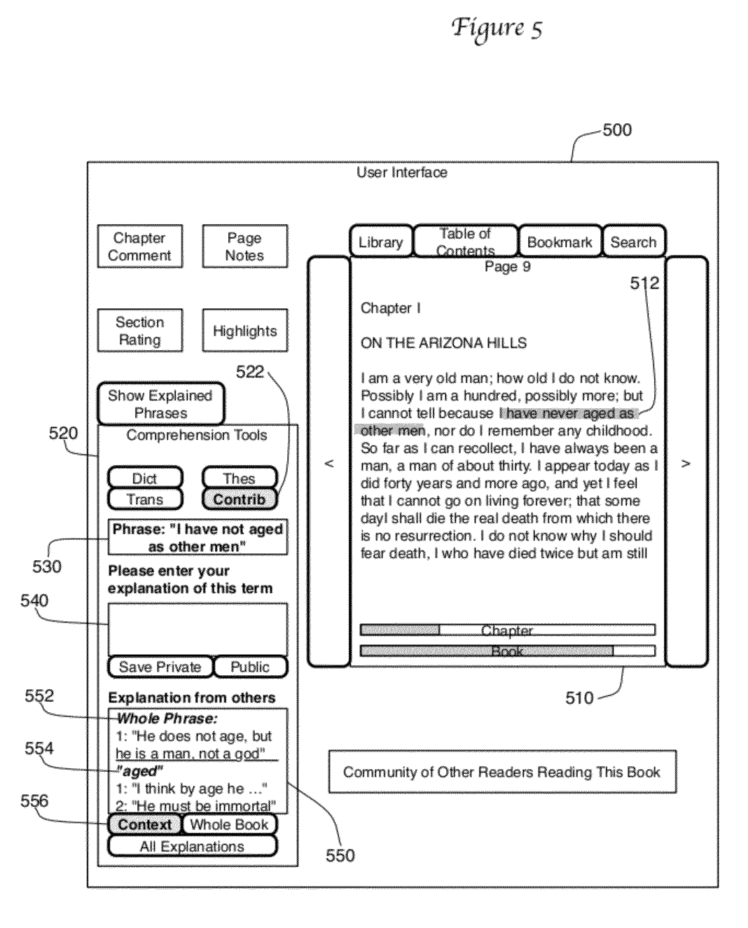

FIG. 5 shows a similar user interface 500, but in this case the user has selected an entire phrase 512 (“I have never aged as other men”) on the displayed page 510. The comprehension tools 520 is again showing contributed explanations, as indicated by the shading in button 522. The entire selected phrase 512 is represented in the comprehension tools box at location 530 to emphasize that any contributed explanation will relate to this entire phrase. In this case, the user has not entered any explanation in the input box 540. If the user did enter and save an explanation, the computerized system 100 would create an explanation database entity 354, as described above, and this entity 354 would identify this entire phrase 512 as the page portion 350 to which it relates. Even without any explanation being provided by the current user, the comprehension tool box 520 will display explanations for this phrase made by other users in box 550. The first explanation provided in box 550 in FIG. 5 relates to this entire phrase, and is therefore preceded by the “whole phrase” header 552. Frequently, users may select a phrase in a book that has not been identically selected by other users who have contributed explanations to the system 100. Nonetheless, users may have contributed explanations for sub-portions of the phrase, such as “I have never aged” or “as other men,” or even explanations for single words within the phrase. Explanations for these “overlapping” page portions are also shown in box 550 in FIG. 5. Overlapping page portions may include subset phrases (meaning phrases that form a portion of another phrase), superset phrases (meaning phrases that completely contain another phrase), and intersecting phrases (meaning phrases that have a portion identical to a portion in another phrase). In this case, the explanation box 550 is also showing the first two explanations stored in the database 210 for the term “aged” as used in this context.

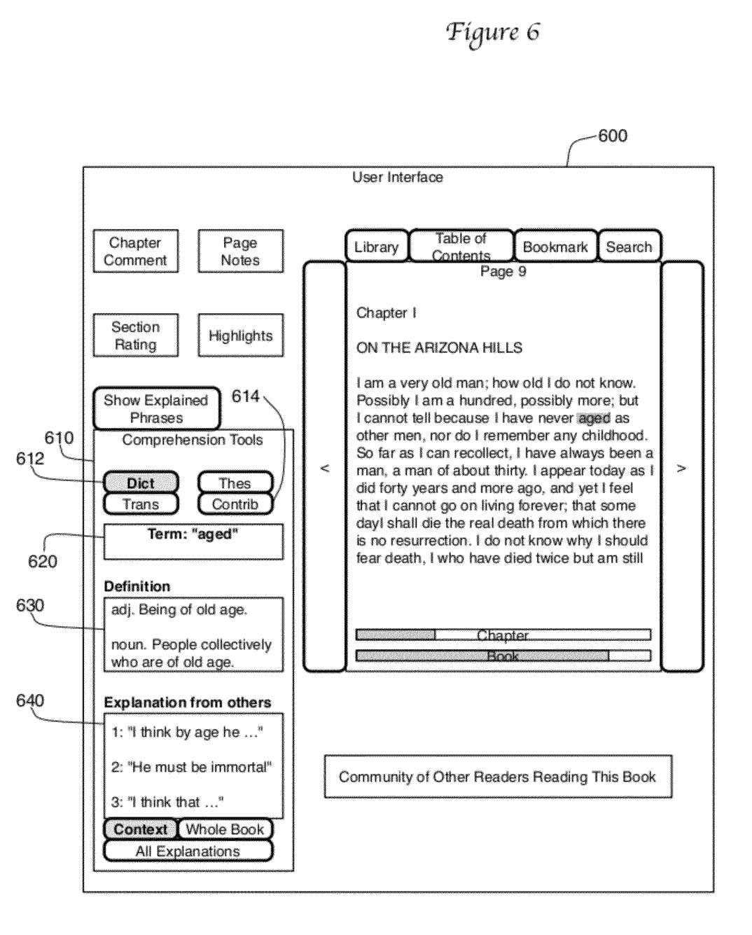

In FIG. 6, the user has again selected only the term aged. However, in this case the user has selected the Dict button 612 in the comprehension tools box 610, meaning that the user is desiring to see a dictionary definition for the term. Once again, the selected term is re-presented in the comprehension tools box 610 at location 620 to avoid any user confusion. To implement the dictionary tool, the computerized system 100 contains a dictionary database of defined terms, such as within non-volatile memory 102. The dictionary database is consulted for the selected term, and if a definition is found it is presented at location 630. In addition to the definition, the comprehension tools 610 will also present the user supplied explanations at location 640. These explanations (and the scope buttons located at the bottom of the explanations 640) are the same that would be provided if the contribution button 614 had been selected by the user. The main difference is that the dictionary tool shown in FIG. 6 contains a definition 630 instead of the input box 480 that allows the user to submit an explanation for the selected text in FIG. 4.

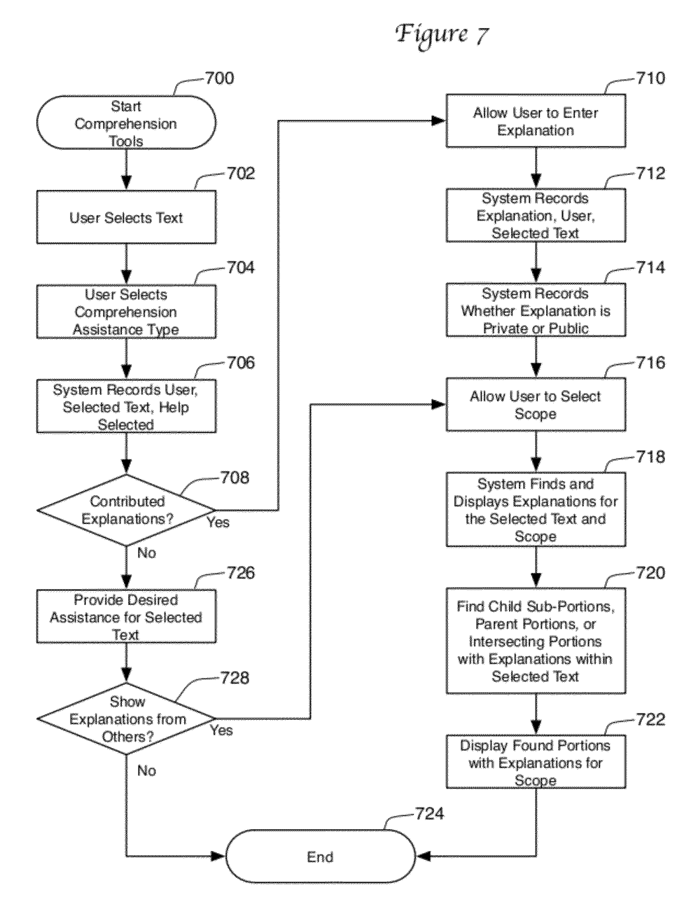

FIG. 7 shows a flowchart showing the process for using the comprehension tools described above. The first step 702 allows a user to select text on the displayed page of this book. This is typically accomplished by using a mouse and clicking (or clicking and dragging) a cursor on the desired text. At step 704, the user selects the type of comprehension assistance that they desire, such as a dictionary, a thesaurus, a translation, or an ability to review and contribute a user supplied explanation for the text. In the above embodiments, this is accomplished by selecting an appropriate button. Obviously, any other known user interface element for allowing user selection could be incorporated at this step without exceeding the scope of the present invention.

At step 706, the system records the fact that the user has selected a particular type of comprehension assistance for the selected text portion in the database 210. In the preferred embodiment, this information is stored in the portion clicks database entity 356. As explained above, this database entity 356 stores interactions that users have with page portions 350 while using the computerized system 100. This allows the system 100 to examine this data 350 later to understand when a user may have encountered difficult with a particular passage, or perhaps otherwise found the passage interesting and relevant. If necessary, this step 706 also creates the page portion entity 350 for the user selection.

Step 708 determines whether the user selected to make and review explanation contributions for the selected page portion. If so, step 710 allows the user to enter their explanation for the selected text, such as in box 480 or 540, as shown in FIGS. 4 and 5 respectively. If the user enters texts and elects to save the explanation, the system records the explanation in database entity 354 at step 712. The entity 354 will record the inputted explanation text, an identification of the user that selected the text (such as through a link to a user record 300 for that user), and an identification of the selected text being explained (such as through a link to a page portion entity 350 for the selected text). In some embodiments, the computerized system 100 may need to create the page portion database entity 350 at the same time the explanation entity 354 is created. In other cases, the page portion entity 350 will have been created earlier, as would be the case if the entity 350 were created as part of step 706 or in connection with an earlier explanation 354 or highlight 352 for this portion. In still other embodiments, the identification of the highlighted text is not accomplished by linking to a distinct page portion database entity 350, but by incorporating the identification information directly within the explanations database entity 354 itself. When the explanation is being saved to the database 210, the computerized system 100 will also indicate whether the explanation is to remain private and only viewable to the user that created the explanation, or whether this explanation is public and may be viewed by other users. This can be done at the same time as the explanation database entity is added in step 712, but is represented by a separate step 714 in FIG. 7.

The computerized system 100 allows the user to view the explanations already in the database 210 for the selected text. This portion of the process 700 begins by allowing the user to select a desired scope for the displayed explanations in step 716. As explained above, the scope may be contextual, meaning that the displayed explanations are limited to those explanations made for this text located at the same location of the same book, or non-contextual. Examples of non-contextual scope include explanations of the same highlighted text but from other locations in the same book, or from other books altogether.

At step 718, the computerized system 100 finds explanation database entities 354 for the selected text based on the selected scope. If the scope is contextual, the system 100 need only search for explanation database entities 354 relating to the same page portions 350 of the book 310. If the scope is non-contextual, step 718 will need to determine the actual text selected by the user, and then search for explanation entities 354 related to the same text. If the non-contextual scope is limited to explanations within the same book (or, in other embodiments, with a chapter or a section of the book, or within a series of books by the same author), then this limitation must be used to filter the discovered explanation entities 354. These explanations are then displayed to the user in step 718.

As explained above in connection with FIG. 5, it can be useful to display explanations 354 for page portions 350 that overlap with the selected text. The test for whether portions overlap will vary depending upon the scope selected by the user. If the user selected a contextual scope, the overlapping text portions 350 must be for the same portion of the displayed page as the selected text. If the scope is non-contextual, the overlapping text portions 350 will be for some or all of the same words as the selected text, but need not be from the same page of the same book. Once explanations entities 354 relating to overlapping page portions 350 for the selected context are discovered in step 720, these explanations are displayed in step 722. At that point, the process 700 ends at step 724.

If contributed explanations were not selected as the desired comprehension assistance in step 704, then step 726 will follow test 708. At step 726, the desired assistance is provided for the selected text. The disclosed embodiment discusses providing dictionary definitions, thesaurus entries, and translations as three types of comprehension assistance that could be provided along with contributed explanations. It would be within the scope of the present invention to provide other types of assistance as well at this step 726. In some cases, it will be helpful to provide a user with contributed explanations along with these other types of assistance, as was shown in FIG. 6 in the context of providing a dictionary definition. If contributed explanations are desired, as determined at step 728, the method 700 continues at step 716. If no contributed explanations are desired, the method ends at step 724.

FIG. 8 shows a user interface 800 where the user has selected the “show explained phrases” button 810, which was also shown in FIG. 4 as button 450. When the button 810 is selected, the button 810 becomes shaded as shown in FIG. 8 and the text of the displayed page is altered to emphasize those page portions 350 that are associated with stored explanations 354. In FIG. 8, this emphasis is provided at locations 820 by changing the background behind the appropriate words and phrases. This emphasis allows the user to tell at a glance that the three highlighted phrases have all been explained by other users, and that these explanations can be viewed by the user as desired. Because the user has not selected any particular one of these page portions, the comprehension tool box 830 does not show any of the explanations 354. Rather, the tool box 830 displays instructions 832 instructing the user to select a word and phrase and to select one of the tool buttons to access comprehension assistance for that selection.

The embodiment of interface 800 FIG. 8 also shows a “request help” button 840. This button allows a user to specifically identify a page portion 350 that they do not understand. Once a user selects a page portion and then clicks the request help button 840, other users will be notified that someone desires a contributed explanation to be made for that page portion. Portions where explanations are desired by other users can be showed on the interface 800 in a variety of ways. In FIG. 8, the phrase “some day I shall die the real death from which there is no resurrection” is displayed in italic font. In this embodiment, the italic font is used to indicate that a third party has requested help for this phrase. A user may see this request for help and be motivated to contribute an explanation for that phrase. In one embodiment, whenever a user requests help, an explanations database entity 354 is created. Text related to the request for help can be added by the user that is requesting help. The entity 354 records that this is not a normal explanation but a request for help, which prevents the request text from being displayed as a submitted explanation for this page portion 350.

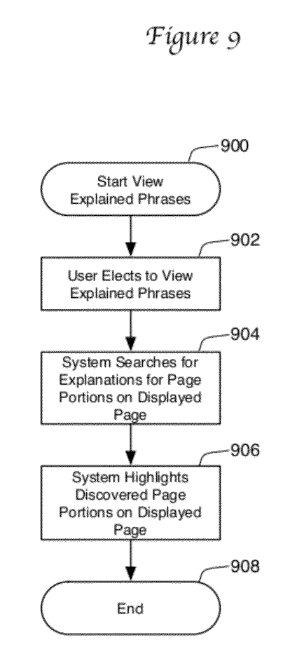

FIG. 9 shows the method 900 used by the computerized system 100 to identify page portions on the currently displayed page that have been the subject of contributed explanations. The method 900 starts with the user electing to view the words and phrases that have been explained. In the embodiment of FIG. 8, this is accomplished by selected the “Show Explained Phrases” button 810. The computerized system 100 then searches the explanation entities 354 in the database 210 to identify those explanation entities 354 that relate to page portions 350 related to the page 340 currently being shown to the user. Once the relevant explanations 354 and page portions 350 have been identified, the computerized system sends instructions to the user interface 800 to alter the appearance of these page portions 350, such as by changing the background behind those portions. This is accomplished at step 906. This step can include altering the appearance of page portions 350 for which help has been requested. The method then ends at step 908.

One benefit of storing data in the database entities described above is that it allows the computerized system 100 to mine this data for useful information. User reading behavior data 224, such as the fact that a user viewed a definition, a user contributed explanation, or a translation for a page portion, can be stored in portion clicks database entities 356 and immediately be associated with the page portions 350 and pages 340 where these events occurred. In addition, page clicks 348 track user interaction with the pages, thereby allowing the system to see how long a user spends on each page, whether a user has stopped reading a book, and if the user stop reading the book, at what page this event occurred. In addition to the user reading behavior data 224, the user community additions data 222, such as the explanations 354, highlights 352, page notes 346, and chapter comments 332, provide immediate feedback on the quality, clarity, and usefulness of the relevant page portions 350, pages 340, and chapters 330 of a book. In the preferred embodiment, other users can view the user community additions 222, and provide feedback on the additions. For instance, a user may rank a chapter comment a “5” (out of 5) but rank an explanation a “2” (out of 5). If multiple rankings are obtained on the user community additions 222, the computerized system can learn which of the additions 222 are most valuable, and can also learn which user is contributing the most valuable additions 222 to the community.

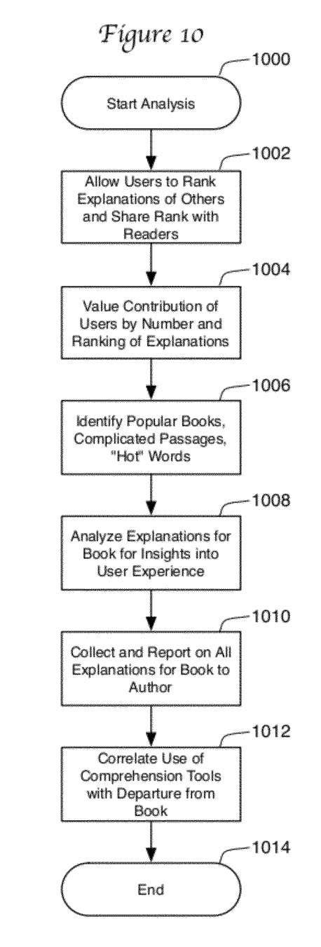

The process 1000 shown in FIG. 10 shows some of the steps that might be used to analyze this data. In step 1002, the computerized system 100 allows other users to rank the explanations 354 provided by other users. These ranks may be aggregated with the ranking of other users in order to provide an overall score or rank for an explanation. This overall score can be provided to users so that they know which explanations 354 have been most valued by other readers. The overall rank can also be used to sort explanations when multiple explanations have been provided that are relevant to a selected page portion 350. As shown in step 1004, these explanation rankings can also be used to determine a valuation score for the contributions made by an individual user. Users with multiple, high ranking contributions 222 (including explanations 354) will have a higher valuation score than users with fewer and lower ranking contributions 222. Highly valued contributors can be given special status within the community, and their community additions 222 can be recognized as coming from a highly valued contributor to the community.

By monitoring both user community additions 222 (such as highlights 352 and explanations 354) as well as user behavior (such as page clicks 348 and portion clicks 356), the computerized system 100 can identify and distinguish between authors, books, and portions of the book in step 1006. For instance, the system can identify the most popular author by comparing page clicks in the author's books, or identify the author with the most devoted fans by measuring community contributions made to the author's books. The computerized system 100 could also identify passages in books that are more complicated by examining reading speed (page clicks 348) and the number of requests for comprehension assistance (dictionary definitions, contributed explanations, translations, thesaurus entries) made by users when reading those passages. The system 100 could even identify “hot” words or phrases that appear across multiple books but seem to be the subject of much interest by users (by examining, for instance, the page portion text of contributed explanations made throughout the system).

At step 1008, the computerized system could provide valuable feedback to authors and publishers by analyzing the contributed explanations 354 made by readers of a book. If readers are contributing numerous explanations relating to a single area of the book, that area may be generating a lot of reader excitement and joy, or it may be generating much reader confusion. In either case, the author would be pleased to get the feedback from the computerized system 100. In fact, the author herself could make provide an explanation 354 to a particularly popular page portion 350 if she so desired.

In step 1010, the computerized system 100 goes beyond reporting about portions of the author's book that are generating intense interest among readers, and actually reports all of the user contributed explanations 354 to the author. This will give the author insight into the experience that users are having with the author's book.

Finally, at step 1012, the computerized system 100 uses the page clicks 348 to determine where users have stopped reading a book, and then analyzes the user's use of the comprehension tools using the portion clicks database entities 356. The system 100 may find a correlation between users use of the comprehension tools in a portion of the book, and the user's decision to stop reading the book in the middle of that portion. If this information is reported to the author, the author will learn not only where readers have stopped reading the book, but what words and phrases in that portion of the book seemed to be causing the most reader confusion. This will allow the author a chance to revise that portion of the book in a later edition (a useful feature in non-fiction and educational books), or to provide direct author community additions 232 for that section in order to help readers through their difficulties. After step 1012 is completed, the method 1000 ends at step 1014.

Of course, the system and methods described above are exemplary and are not the exclusive techniques for using the disclosed embodiments. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method of contributing content relating to a text document comprising:
on a server computer having a processor and tangible, non-transitory computer-readable memory containing structured data in a computerized database,
a) at the server computer, transmitting a web interface to a first user computer and a second user computer, the web interface displaying the text document, the first and second user computers being associated by the server computer with a first and second user database element, respectively, in the database;
b) at the server computer, receiving a first request from the first user computer to contribute an explanation of a first text portion of the text document, the request identifying the first text portion and explanation text;
c) at the server computer and in response to the request, storing in the database an explanation database element identifying
i) the first text portion,
ii) the explanation text, and
iii) the first user database element;
d) at the server computer, receiving a second request from the second user computer to view explanation texts associated with a second text portion;
e) at the server computer, identifying an overlap between the first text portion and the second text portion;
f) at the server computer, transmitting the explanation text and the first text portion from the explanation database element to the second computer for display on the web interface.

2. The method of claim 1, wherein the first text portion is the same as the second text portion.

3. The method of claim 1, wherein one of the first and second text portions is a subset of the other of the first and second text portions.

4. The method of claim 1, wherein the second text portion comprises a single word, and further wherein the web interface on the second computer is further displaying a definition of the single word.

5. The method of claim 1, wherein the first and second portions are identified as occurring on a single page of a single document.

6. The method of claim 5, wherein the first and second text portion are both associated by the server computer with a single page database element in the database.

7. The method of claim 1, wherein the database contains a plurality of explanation database elements having text portions that overlap with the second text portion, and further wherein the server computer transmits to the second computer explanation texts from the plurality of explanation database elements that overlap the second text portion.

8. The method of claim 7, wherein the server computer identifies the overlap by comparing the location of text portions within the text document.

9. The method of claim 7, wherein the server computer identifies overlap by determining document content for each text portion and comparing the document content.

10. The method of claim 7, wherein the second request indicates a scope for desired explanation texts.

11. The method of claim 10, wherein the scope is the context of the second portion, and further wherein the server computer identifies overlap by comparing the location of text portions within the text document.

12. The method of claim 10, wherein the scope is noncontextual, and further wherein the server computer identifies overlap by comparing the content of text portions identified in the explanation database elements with the content of the second text portion identified in the second request.

13. The method of claim 12, wherein the noncontextual scope is limited to a document in which the second text portion is found.

14. The method of claim 7, further comprising:
g) at the server computer, receiving from the second computer a rating pertaining to a particular explanation text; and
h) storing the rating in the database in association with the particular explanation database element containing the particular explanation text.

15. The method of claim 14, wherein the server computer transmits to the second computer analyzes the rankings stored in the database for the plurality of explanation database elements, and transmits to the second computer data relating to the analyzed rankings along with the explanation texts from the plurality of explanation database elements.

16. The method of claim 1, further comprising:
g) at the server computer, receiving from the second computer a rating pertaining to the explanation text and storing the rating in the database in association with the explanation database element.

17. The method of claim 16, wherein the server computer establishes a value score for a plurality of user database elements, wherein the value score is based in part on a count of explanation database elements identifying each user database element as well as based on ratings associated with explanation database elements identifying each user.

18. A method of analyzing user experience with text documents read over a network connection comprising:
on a server computer having a processor and tangible, non-transitory computer-readable memory containing structured data in a computerized database,
a) at the server computer, storing in the database a text document database element that identifies
i) text to be read over the network connection, and
ii) an author
b) at the server computer, storing in the database a plurality of explanation database elements, with each explanation database element identifying
i) the text document database element,
ii) a text portion of the text document,
iii) an explanation text created by a reader, and
iv) a user database element associated with the reader;
c) at the server computer, analyzing the explanation database elements to identify areas of the text document containing a plurality of text portions identified in the explanation database element; and
d) at the server computer, reporting the analysis of step c) to the author identified in the text document database element.

19. The method of claim 18, further comprising:
e) at the server computer, identifying defection locations in the text documents where users stop reading the text document over the network location; and
f) at the server computer, correlating the defection locations with the explanation database elements identifying the text document element for the text document.

20. The method of claim 18, further comprising:
e) at the server computer, storing in the database a plurality of portion click database elements, with each portion click database element identifying:
i) the text document database element,
ii) a text portion of the text document,
iii) a comprehension tool selected by a user for the text portion; and
iv) a user database element associated with the user;
f) at the server computer, analyzing the portion click database elements to identify areas of the text document containing a plurality of text portions identified in the portion click database elements; and
g) at the server computer, reporting the analysis of step f) to the author identified in the text document database element.

21. A server computer system comprising:
a) at least one processor for processing computer instructions;
b) a network interface for communicating with a remote user computer over a network;
c) tangible, non-transitory computer readable memory:
d) structured data residing on the non-transitory memory containing explanation database elements, with each explanation database element identifying a text portion in a text document, explanation text, and a user database element;
e) programming instructions residing on the non-transitory memory, the programming instructions instructing the processor to:
i) receive from a request from the remote computer to view explanation texts associated with a specific text portion of the text document,
ii) identify a plurality of explanation database elements in the database having text portions overlapping with the specific text portion identified in the request,
iii) transmit the explanation texts from the identified plurality of explanation database elements to the remote computer

22. The server computer system of claim 21, wherein the programming instructs the processor to identify the overlap by comparing the location of text portions within the text document.

23. The server computer system of claim 21, wherein the programming instructs the processor to identify the overlap by determining document content for each text portion and comparing the document content.
